(19) United States
(12) Patent Application Publication
(10) Pub. No.: US 2026/0324773 A1
(43) Pub. Date: Oct. 22, 2026

(54) TRI-FOLD FILTER MASK AND MANUFACTURING PROCESS

(71) Applicant: XIAMEN PINZTEC CO., LTD, Xiamen (CN)

(72) Inventor: Xianhua YANG, Xiamen (CN)

(73) Assignee: XIAMEN PINZTEC CO., LTD, Xiamen (CN)

(21) Appl. No.: 19/709,582

(22) Filed: Jun. 16, 2026

Related U.S. Application Data
(63) Continuation of application No. PCT/CN2023/095096, filed on May 18, 2023.

(30) Foreign Application Priority Data
May 18, 2023 (WO) PCT/CN2023/095096

(51) Int. Cl. A41D 13/11

(52) U.S. Cl. CPC A41D 13/1123; A41D 2400/38

(57) ABSTRACT

A manufacturing process for a tri-fold filter mask includes Step 1 of preparing a tri-fold mask integrally formed from non-woven fabric into an upper sheet body, a middle layer body and a lower sheet body, wherein a filter layer and an additional non-woven fabric layer are respectively arranged on the outer side of each of the upper sheet body and the lower sheet body; Step 2 of preparing rigid and porous support material as well as soft, napped filter material; Step 3 of laminating the support material and the filter material and folding them at preset folding height and folding times to form a folded wave-shaped structure; Step 4 of placing the folded filter material on the middle layer body of the tri-fold mask, covering the folded filter material with a piece of non-woven fabric, and performing edge sealing on the tri-fold mask and the non-woven fabric.

### CROSS-REFERENCE TO RELATED APPLICATIONS

The application claims priority to PCT international application No. PCT/CN2023/095096, filed on May 18, 2023, the entire contents of which are incorporated herein by reference.

### TECHNICAL FIELD

The present invention belongs to the technical field of masks, in particular to a tri-fold filter mask and a manufacturing process for producing the tri-fold filter mask.

### BACKGROUND

Face masks are generally worn over the mouth and nose to filter the air entering these areas, blocking harmful gases, odors, droplets, and particulate matter from entering or exiting the wearer's mouth and nose. This prevents particulate matter and bacteria from entering the lungs, thereby protecting people's health. With the improvement of living standards and increased awareness of personal protection, the frequency of mask-wearing in daily life has risen significantly. For instance, in cities with heavy smog, during outbreaks of respiratory infectious diseases, or when working in dusty or polluted environments, masks have become essential items for specific job roles and daily travel.

However, while masks can filter airborne pollutants, they also cause breathing difficulties. To reduce breathing resistance and improve breathability and filtration efficiency, existing masks can only achieve this by altering the type of filter material or the mask's dimensions. Using current mask technology, it is not yet possible to achieve these improvements without changing the type of filter material or the mask's dimensions.

Conventional disposable masks are mainly composed of three or multiple layers of raw materials. Their standard fabrication proceeds by laying and stacking each material layer flat, followed by thermal bonding, cutting and other forming procedures. As a result, the effective filter area of such masks approximates their outer surface area, leading to unsatisfactory breathability.

### SUMMARY

### Technical Problem

The objective of this invention is to provide a tri-fold filter mask that is sturdy and durable, resistant to collapse, highly breathable, lightweight, and comfortable to wear, as well as to provide a manufacturing process for such a tri-fold filter mask.

### Technical Solution

To achieve the above objectives, the solution of the present invention is as follows: a tri-fold filter mask comprises a middle filter layer body, and an upper sheet body and a lower sheet body connected to upper and lower side edges of the middle filter layer body. The upper sheet body and the lower sheet body are folded or unfolded relative to the middle filter layer body. The unfolded upper sheet body, the middle filter layer body, and the lower sheet body enclose a filter cavity for covering the mouth and nose. The middle filter layer body is provided with a filter element formed into a folded wave shape by means of multiple folded bends, so as to increase the filter area of the filter cavity.

As a further improvement, the inner surface of the upper sheet body is provided with a shaping strip at the nose bridge.

A manufacturing process of the tri-fold filter mask comprises the following steps:
Step 1: Manufacturing the tri-fold mask: The tri-fold mask consists of an upper panel, a middle layer, and a lower panel formed as a single unit from non-woven fabric. The outer sides of the upper panel and the lower panel each have a filter layer and another layer of non-woven fabric, which are pressed together using a calender; this leaves only the middle layer as a single layer of non-woven fabric. A continuous roll of tri-fold mask material is prepared;
Step 2: Prepare the support material and filter material: Non-woven fabric is modified under controlled temperature to obtain rigid and porous support material, which is then wound into continuous rolls of support material. Non-woven fabric is modified under controlled temperature to prepare soft, napped filter material, and continuous rolled filter material is produced accordingly.
Step 3: Fabricate folded filter material: After confirming the mask outline as well as preset folding height and folding quantity, outline calculation is performed via drawing software to acquire the dimensional data of the flat-laid support material before folding. A rotary cutter matching the outer contour of the middle layer body is manufactured according to the dimensional data. The rolled support material is conveyed to the rotary cutter, which cuts the outline of the middle layer body on the support material while leaving several connecting joints between the cut part and leftover scrap without full severance. Subsequently, the support material is further conveyed to a folding mechanism. The support material and filter material are laminated and folded in accordance with the preset folding height and folding times to form a folded wave shape. During folding, the support material and filter material are bonded together by friction for shaping, thereby obtaining continuous folded filter material with corrugated folded configuration.
Step 4: Fabricate the tri-fold filter mask: The tri-fold mask is fed from the rolled tri-fold mask stock. The folded filter material is placed onto the middle layer body of the tri-fold mask, and a piece of non-woven fabric is laid over the folded filter material. A forming roller conforming to the outer contour of the middle layer body is fabricated based on the aforementioned dimensional data. Finally, the forming roller seals the peripheral edges of the tri-fold mask and the overlying non-woven fabric along the contour of the middle layer body while stripping waste scraps from the support material, so that the folded filter material is encapsulated between the tri-fold mask and the non-woven fabric to obtain the finished tri-fold filter mask.

As a further improvement, in Step 3, the outer contour dimension of the filter material is larger than that of the support material.

As a further improvement, the outer contour dimension of the support material is smaller than and close to the outer contour of the middle layer body.

As a further improvement, in Step 4, the forming roller presses and thermally welds the edges of the tri-fold mask and the non-woven fabric to complete edge sealing.

As a further improvement, the folding direction of the folding mechanism is transverse.

As a further improvement, the process further comprises Step 5 for preparing wearing portions on both sides of the mask, wherein the wearing portions are left and right ear loops or head straps wrapping around the head.

As a further improvement, the filter layers of the upper sheet body and the lower sheet body are flat-laid melt-blown fabric.

As a further improvement, the support material and the filter material are made of PP material.

### Beneficial Effects

After adopting the above technical solution, the present invention achieves the following beneficial effects:

The mask prepared by the present invention features a simple and lightweight overall structure, which is mainly composed of three unfoldable and foldable cover bodies including an upper sheet body, a lower sheet body and a low-resistance middle layer body. The upper sheet body and the lower sheet body can be folded or unfolded relative to the middle layer body to realize a folded storage state or an unfolded use state. The mask is compact and portable when folded for storage; after unfolding, the three components jointly form a filter cavity covering the mouth and nose. Benefiting from the tri-fold structure, the volume and effective area of the filter cavity are increased to a certain extent, providing larger breathing space and improved wearing comfort for users. In combination with the wave-shaped folded structure of the folded filter material, the gas flow channel is further expanded, which greatly reduces breathing resistance, improves mask breathability and optimizes overall wearing experience.

The present invention enjoys favorable processability, and various mask configurations with enhanced sealing performance can be designed as required.

The waste material remains connected during folding to maintain structural stability; without the connecting waste, the outer contour is prone to crush damage, and the waste can be torn off in the subsequent working procedure.

Conventionally, to produce the folded filter material of the present invention according to existing technologies in the field, two pieces of filter paper need adhesive spraying to achieve bonding performance for convenient folding. However, the applied adhesive tends to block pores and raise breathing resistance, and the adhesive composition may cause potential health hazards. Besides, hot melt adhesive is generally adopted to fix folding spacing after shaping, which leads to excessive transverse rigidity and prohibits bending of filter materials. In contrast, the present invention specially adopts rigid and porous support material as well as soft, napped filter material, which are bonded into composite material via friction. The composite material owns longitudinal rigidity for shape retention together with transverse flexibility, so it can bend to match the facial radian during mask wearing. The finished filter part is sturdy and anti-collapse while retaining porous structure for lightweight breathability. No adhesive is needed, thereby eliminating all defects induced by adhesive.

### BRIEF DESCRIPTION OF DRAWINGS

FIG. 1 is a schematic outer structural view of the mask according to the present invention;

FIG. 2 is a schematic inner structural view of the mask according to the present invention;

FIG. 3 is a structural schematic view when the upper sheet body is folded toward the middle layer body of the present invention;

FIG. 4 is a structural schematic view of the mask of the present invention after storage folding;

FIG. 5 is a structural schematic view where the wearing portions of the mask are ear loops;

FIG. 6 is a structural schematic view where the wearing portions of the mask are head straps;

FIG. 7 is an exploded schematic view of the middle layer body of the present invention;

FIG. 8 is a schematic view illustrating the manufacturing process of the mask of the present invention.

### REFERENCE NUMERALS

1: Middle layer body; 11: Non-woven fabric; 12: Folded filter material; 121: Support material; 122: Filter material roll; 123: Waste scrap; 2: Upper sheet body; 3: Lower sheet body; 4: Filter cavity; 5: Ear loops; 6: Head straps; 7: Sponge; 8: Rotary cutter; 9: Folding mechanism; 10: Forming roller

### DETAILED DESCRIPTION OF THE EMBODIMENTS

The technical solutions in the embodiments of the present invention will be described clearly and completely with reference to the accompanying drawings of the embodiments. Apparently, the described embodiments are preferred embodiments of the present invention and shall not be construed as exclusion of other embodiments. All other embodiments obtained by those ordinarily skilled in the art based on the embodiments herein without creative efforts shall fall within the protection scope of the present invention.

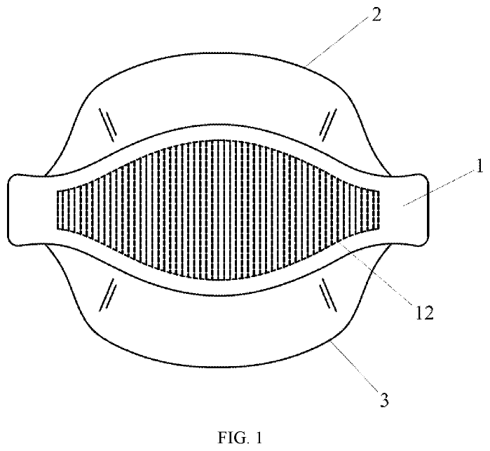

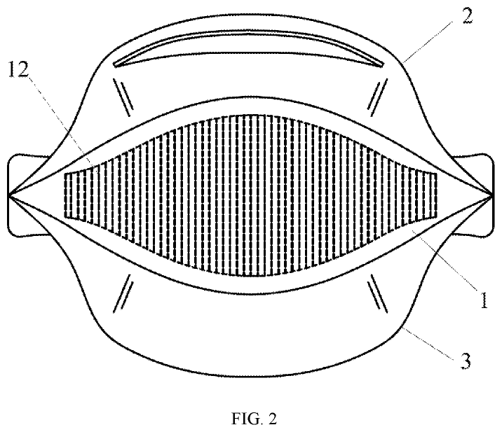

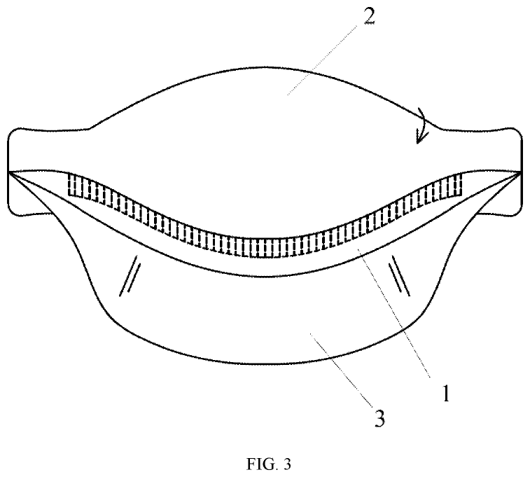

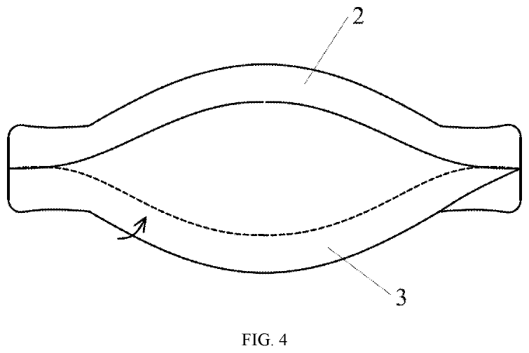

The present invention provides a tri-fold filter mask. As shown in FIG. 1, the mask comprises a middle layer body 1, as well as an upper sheet body 2 and a lower sheet body 3 connected to the upper and lower side edges of the middle layer body 1. The upper sheet body 2 and the lower sheet body 3 can be folded or unfolded relative to the middle layer body 1. As illustrated in FIG. 2, the unfolded upper sheet body 2, middle layer body 1 and lower sheet body 3 jointly define a filter cavity 4 on the inner side for covering the mouth and nose. For storage of the tri-fold filter mask, the upper sheet body 2 is first folded toward the middle layer body 1 as shown in FIG. 3, and subsequently the lower sheet body 3 is folded toward the middle layer body 1 and stacked over the upper sheet body 2 as shown in FIG. 4, so the three components are folded together for compact storage to realize the tri-fold structure. The tri-fold structure enlarges the overall space of the mask and increases the area of the filter cavity 4, achieving improved wearing comfort and smoother breathing space for users.

On this basis, the middle layer body 1 is equipped with folded filter material 12, which is formed into a folded wave shape via repeated bending to expand the effective filtering area of the filter cavity 4. In accordance with the pressure formula P=F/S, when the applied pressure F remains unchanged, increasing the filtering area S reduces pressure P. With constant penetration resistance F, the folded structure can multiply the effective filtering area S by adjusting folding height and folding quantity, thus lowering pressure P namely breathing resistance and greatly improving the mask's breathability.

In a preferred embodiment, constituent materials of the tri-fold filter mask are specified as follows:

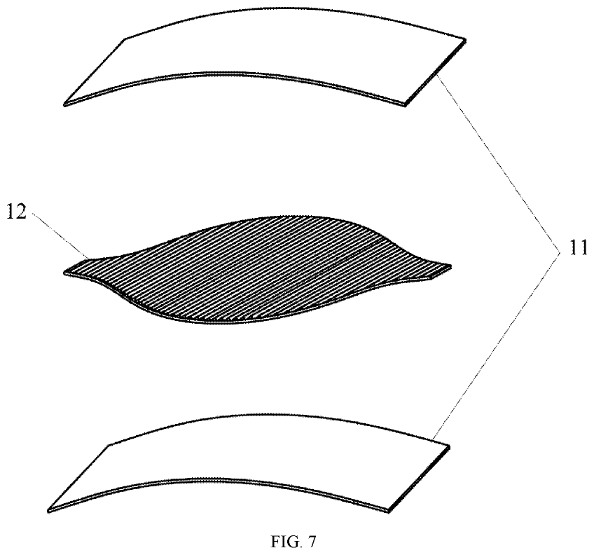

Folded filter material 12: As shown in FIG. 7, non-woven fabrics 11 are arranged on the inner and outer sides of the folded filter material 12 to wrap the folded filter material 12 and form the middle layer body 1. Encapsulation between two layers of non-woven fabrics prevents sliding displacement of the folded filter material, features simple construction and retains favorable breathability, with no specific limitation imposed on the filter medium of the folded filter material.

Upper sheet body 2 and lower sheet body 3: The upper sheet body 2 and the lower sheet body 3 may adopt identical symmetrical structures or asymmetrical configurations, each constructed by laminating non-woven fabric, filter layer and another non-woven fabric. The filter layer is made of flat-laid melt-blown fabric, rendering the upper and lower sheet bodies soft and adaptable to fit human facial contours.

All raw materials adopted for the tri-fold filter mask are lightweight, with concise and neat overall structure, so the finished mask is light in weight and convenient to carry.

The middle layer body 1 is designed into an olive shape wider at the center and gradually narrowed toward both ends. Such configuration avoids internal sliding of the folded filter material 12 and realizes superior facial fitting performance and protective effect complying with ergonomic design.

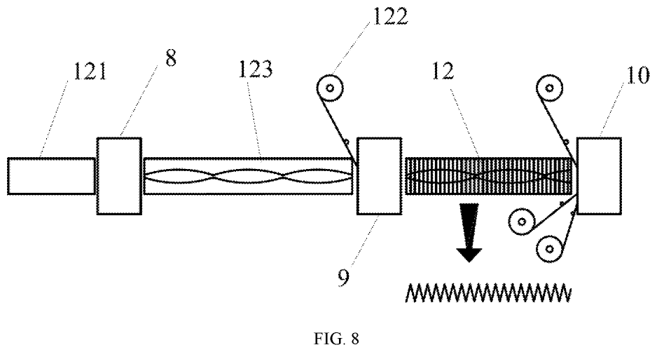

The present invention further discloses a manufacturing process for the tri-fold filter mask as depicted in FIG. 8, including the following steps:
Step 1: Preparing tri-fold mask base stock. The tri-fold mask base consists of an integrally formed upper sheet body 2, middle layer body 1 and lower sheet body 3 made of non-woven fabric.

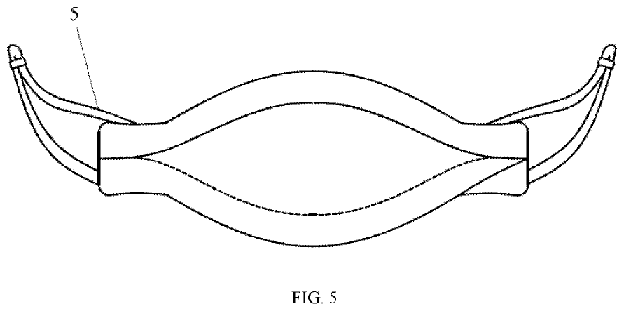

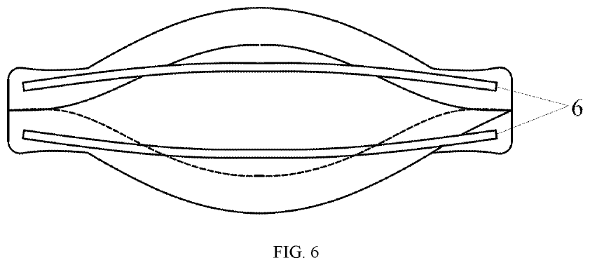

A filter layer and an additional non-woven fabric layer 11 are respectively disposed on the outer surface of the upper sheet body 2 and the lower sheet body 3 and compression-bonded via pressing rollers, leaving the middle layer body composed of a single layer of non-woven fabric 11. Continuous rolled stock of the tri-fold mask is consequently obtained.
Step 2: Preparing support material and filter material. Non-woven fabric is thermally modified under controlled temperature to produce rigid and porous support material 121, which is wound into continuous support material rolls. Separately, non-woven fabric is modified under controlled temperature to obtain soft, slightly napped filter material, which is made into continuous filter material rolls 122.
Step 3: Fabricating folded filter material. After confirming mask outline as well as preset folding height and folding quantity, outline dimensional data of flat unfolded support material 121 is calculated by drawing software. A rotary cutter 8 matching the outer contour of the middle layer body is processed according to the dimensional data. The rolled support material 121 is conveyed to the rotary cutter 8, which cuts the contour of the middle layer body on the support material while reserving several connecting points between the contoured blank and waste scrap 123 without full severance. The reserved scrap maintains connection between adjacent blank segments to avoid fracture during continuous production and can be easily peeled off in subsequent procedures. Thereafter the support material is fed into folding mechanism 9; the support material and filter material are laminated and folded per preset folding height and folding cycles to form continuous wave-shaped folded filter material 12. The two materials adhere to each other via frictional bonding during folding for shape retention. The outer contour of the filter material is proportionally larger than that of the support material, while the outer dimension of the support material is proportionally smaller than and approximate to the contour of the middle layer body. The oversized filter material prevents deformation of the support material under compression; the filter material is retained in place by friction between napped surface and pores, and the finished folded filter material only needs wrapping by a single layer of non-woven fabric 11.
Step 4: Forming finished tri-fold filter mask. Tri-fold mask base is unwound from the rolled stock, the folded filter material is laid on the middle layer body of the mask base, and a sheet of non-woven fabric 11 is covered over the folded filter material. A forming roller 10 matching the middle layer body's contour is fabricated based on the dimensional data. The forming roller 10 compression-bonds and thermally welds the peripheral edges of the mask base and covering non-woven fabric 11 for edge sealing and simultaneously strips waste scrap 123 off the support material, so the folded filter material is fully encapsulated between the mask base and non-woven fabric 11 to complete the finished tri-fold filter mask. The thermally sealed edge ensures excellent air tightness and structural firmness without auxiliary fixing fittings such as plastic clips.
Step 5: Mounting wearing parts on two lateral sides of the mask. Either of two wearing configurations is optional: ear loops 5 mounted on ears as shown in FIG. 5 or circumferential head straps 6 wrapping around the head as illustrated in FIG. 6; head straps 6 deliver better sealing performance.

The folding direction of the folding mechanism 9 is transverse as shown in FIG. 1 and FIG. 2. Transversely folded filter material 12 enhances longitudinal bending resistance, effectively solving sagging and shape-losing defects of the middle layer body during wearing.

To improve facial conformity, a shaping strip (not shown) is arranged at the nose bridge on the inner surface of the upper sheet body 2 as shown in FIG. 2; sponge 7 attached to the shaping strip fits snugly against the nose bridge for enhanced soft skin-friendly comfort.

Raw materials for the support material and filter material include but are not limited to PP non-woven fabric.

In the claims, specification and appended drawings of the present invention, terms such as “comprise”, “include” and their variations are intended to mean “including but not limited to”.

The foregoing descriptions merely relate to preferred embodiments of the present invention, and the design conception is not limited thereto. Any non-substantial modification based on the conception, equivalent alteration and amendment falling within the scope of the patent and specification shall be covered by the protection scope of the present invention.

What is claimed is:

1. A tri-fold filter mask, characterized in that the mask comprises a middle filter layer body, an upper sheet body and a lower sheet body connected respectively to upper and lower side edges of the middle filter layer body; the upper sheet body and the lower sheet body are foldable or unfoldable relative to the middle filter layer body, and the unfolded upper sheet body, middle filter layer body and lower sheet body jointly enclose a filter cavity for covering the mouth and nose;
the middle filter layer body is provided with a filter element bent repeatedly into a folded wave shape to increase the effective filtering area of the filter cavity.

2. The tri-fold filter mask according to claim 1, characterized in that a shaping strip is arranged at the nose bridge on the inner surface of the upper sheet body.

3. A manufacturing process for a tri-fold filter mask, characterized by comprising the following steps:
step 1: fabricating a tri-fold mask base; the tri-fold mask base includes an upper sheet body, a middle layer body and a lower sheet body integrally formed of non-woven fabric; a filter layer and an additional non-woven fabric layer are disposed on the outer side of each of the upper sheet body and the lower sheet body and compression-bonded by pressing rollers, so that only the middle layer body is formed of a single layer of non-woven fabric, and continuous rolled stock of the tri-fold mask is prepared;
step 2: preparing a support material and a filter material; a non-woven fabric material is modified under controlled temperature to prepare rigid and porous support material which is wound into continuous rolls; a non-woven fabric material is modified under controlled temperature to prepare soft, napped filter material which is wound into continuous filter material rolls;
step 3: fabricating folded filter material; after confirming the outer contour of the mask as well as preset folding height and folding quantity, dimensional data of the flat laid support material before folding is calculated via drawing software; a rotary cutter matching the outer contour of the middle layer body is manufactured according to the dimensional data; the rolled support material is conveyed to the rotary cutter which cuts the contour of the middle layer body on the support material while reserving several connecting points between the cut part and waste scrap without fully cutting off the scrap; thereafter the support material is conveyed to a folding mechanism, the support material and the filter material are laminated and folded at the preset folding height and folding quantity to form a folded wave shape, the support material and the filter material are bonded together by friction during folding for shaping to obtain continuous folded wave-shaped filter material;
step 4: producing a finished tri-fold filter mask; the tri-fold mask is fed from the rolled mask stock, the folded filter material is placed on the middle layer body of the tri-fold mask and covered with a piece of non-woven fabric; a forming roller conforming to the outer contour of the middle layer body is fabricated based on the dimensional data; the forming roller performs edge sealing on the tri-fold mask and the non-woven fabric along the contour of the middle layer body while stripping waste scrap from the support material to encapsulate the folded filter material between the tri-fold mask and the non-woven fabric, so as to finally obtain the tri-fold filter mask defined in claim 1.

4. The manufacturing process for a tri-fold filter mask according to claim 3, characterized in that in step 3, the outer contour dimension of the filter material is larger than that of the support material.

5. The manufacturing process for a tri-fold filter mask according to claim 4, characterized in that the outer contour dimension of the support material is smaller than and close to the outer contour of the middle layer body.

6. The manufacturing process for a tri-fold filter mask according to claim 3, characterized in that in step 4, the forming roller presses and thermally welds the edges of the tri-fold mask and the non-woven fabric to complete edge sealing.

7. The manufacturing process for a tri-fold filter mask according to claim 3, characterized in that the folding direction of the folding mechanism is transverse.

8. The manufacturing process for a tri-fold filter mask according to claim 3, characterized in that the process further comprises Step 5 of arranging wearing portions on two sides of the mask, wherein the wearing portions are bilateral ear loops or head straps surrounding the head.

9. The manufacturing process for a tri-fold filter mask according to claim 3, characterized in that each filter layer of the upper sheet body and the lower sheet body is made of flat-laid melt-blown fabric.

10. The manufacturing process for a tri-fold filter mask according to claim 3, characterized in that the support material and the filter material are made of PP material.
